(19) United States
(12) Patent Application Publication
(10) Pub. No.: US 2007/0115847 A1
(43) Pub. Date: May 24, 2007

(54) Method and apparatus to estimate link performance in a packetized communication network

(76) Inventors: Guenael J. Strutt, Sanford, FL (US); Sebnem Zorlu Ozer, Altamonte Spring, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/282,353

(22) Filed: Nov. 18, 2005

(51) Int. Cl. H04L 12/26; H04Q 7/00

(52) U.S. Cl. 370/252; 370/332

(57) ABSTRACT

The present invention provides a method and apparatus to estimate link performance in a packetized communication network (100). The method includes identifying one or more system parameters (240) of the packetized communication network (100); obtaining one or more transaction feedback (235) of one or more packetized communications within a communication link (110, 120) of the packetized communication network (100); and estimating performance of the communication link using the identified system parameters (240) and obtained transaction feedback (235).

### FIELD OF THE INVENTION

The present invention relates generally to communication networks; and in particular to link performance estimation mechanisms within packetized communication networks.

### BACKGROUND

Within the growing communications industry, networks utilizing packet switching protocols are becoming more and more prevalent. Packet switching refers to protocols in which messages are divided into packets before they are sent. Each packet is then transmitted individually and can even follow different routes to its destination. Once all the packets forming a message arrive at the destination, they are recompiled into the original message.

Many of today's Wide Area Network (WAN) protocols, including Transmission Control Protocol/Internet Protocol (TCP/IP), X.25, and Frame Relay, are based on packet-switching technologies. Packet switching is more efficient and robust than traditional circuit-switching technology for data that can withstand some delays in transmission, such as e-mail messages and Web pages.

In recent years, a type of mobile communications network known as an “ad-hoc” network has been developed. In this type of network, each mobile node is capable of operating as a base station or router for the other mobile nodes, thus eliminating the need for a fixed infrastructure of base stations. As can be appreciated by one skilled in the art, network nodes transmit and receive data packet communications in a multiplexed format, such as time-division multiple access (TDMA) format, code-division multiple access (CDMA) format, or frequency-division multiple access (FDMA) format.

More sophisticated ad-hoc networks are also being developed which, in addition to enabling mobile nodes to communicate with each other as in a conventional ad-hoc network, further enable the mobile nodes to access a fixed network and thus communicate with other mobile nodes, such as those on the public switched telephone network (PSTN), and on other networks such as the Internet.

As can be appreciated by one skilled in the art, since certain nodes of the ad-hoc network are mobile, it is necessary for the network to maintain connectivity with those nodes. Transmitted data packets typically “hop” from mobile device to mobile device, creating a transmission path, or route, until reaching a final destination. However, transmission paths between mobile devices are often subject to change as devices move, therefore ad-hoc network communication must be able to adapt to achieve optimum performance while addressing the limited capabilities and capacities of mobile individual devices.

In order to optimize network performance, techniques have been developed which enable nodes to select optimum links via which to send data packets between each other. Some techniques estimate link reliability based on signal strength. Unfortunately, signal strength does not necessarily provide an accurate measure of link reliability.

Link quality measurements can also be based on an assessment of the number of errors encountered in a wireless communication channel. Such assessments do not accurately determine the impact of failures, especially of control packet failures.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an example communication network employing a system and method in accordance with an embodiment of the present invention.

FIG. 2 is a block diagram illustrating an example of a communication device employed in the communication network shown in FIG. 1 in accordance with an embodiment of the present invention.

FIGS. 3 through 5 illustrate exemplary system parameters that may be stored in a memory of the communication device of FIG. 2.

FIG. 6 is a flowchart illustrating one embodiment of the operation of a link performance estimator within the communication device of FIG. 2 in accordance with the present invention.

FIGS. 7 through 13 illustrate exemplary communications within the communication network of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a method and apparatus to estimate link performance in a packetized communication network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a method and apparatus to estimate link performance in a packetized communication network described herein. The non-processor circuits may include, but are not limited to, a radio receiver, a radio transmitter, signal drivers, clock circuits, power source circuits, and user input devices. As such, these functions may be interpreted as steps of a method to estimate link performance in a packetized communication network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

As will be appreciated by those of ordinary skill in the art, in traditional packet completion rate (PCR)-based link quality calculation, the penalty for a lost Request to Send (RTS) is the same as for a lost packet. This ensures that broken links are properly detected and dealt with. However, numerous RTS errors are caused by hidden node problems which are common with traditional Carrier Sense Multiple Access/Collision Avoidance (CSMA/CA) Media Access Controls (MACs). Such errors are expected, and in most conditions (i.e. about two or three RTS retries per packet sent) the impact on performance is minimal. Since the route metric (and by extension, the Link Quality values) is representative of the performance, the penalty that is applied for RTS retries should not be as drastic. Preferably, it should be representative of the actual capacity of the link.

The present invention as described herein comprises a method and apparatus to estimate link performance in a packetized communication network. The described invention estimates link performance in a packetized communication network by identifying one or more system parameters of the packetized communication network; obtaining transaction feedback of one or more packetized communications within a communication link of the packetized communication network; and estimating performance of the communication link using the identified system parameters and obtained transaction feedback.

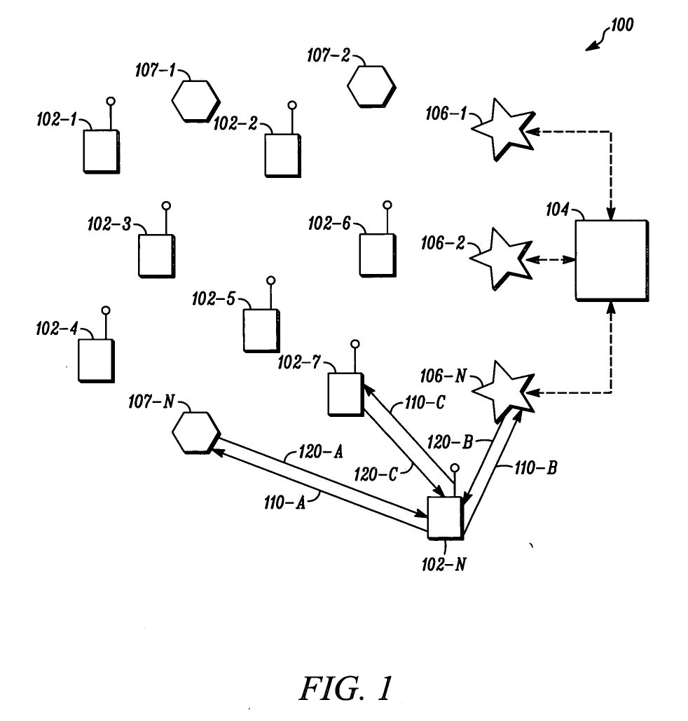

FIG. 1 is a block diagram illustrating an example of a communication network 100 employing an embodiment of the present invention. For illustration purposes, the communication network 100 comprises an adhoc wireless communications network. For example, the adhoc wireless communications network can be a mesh enabled architecture (MEA) network or an 802.11 network (i.e. 802.11a, 802.11b, or 802.11g) It will be appreciated by those of ordinary skill in the art that the communication network 100 in accordance with the present invention can alternatively comprise any packetized communication network. For example, the communication network 100 can be a network utilizing packet data protocols such as TDMA (time division multiple access), GPRS (General Packet Radio Service) and EGPRS (Enhanced GPRS).

As illustrated in FIG. 1, the communication network 100 includes a plurality of mobile nodes 102-1 through 102-n (referred to generally as nodes 102 or mobile nodes 102 or mobile communication devices 102), and can, but is not required to, include a fixed network 104 having a plurality of access points 106-1, 106-2, . . . 106-n (referred to generally as nodes 106 or access points 106), for providing nodes 102 with access to the fixed network 104. The fixed network 104 can include, for example, a core local access network (LAN), and a plurality of servers and gateway routers to provide network nodes with access to other networks, such as other ad-hoc networks, a public switched telephone network (PSTN) and the Internet. The communication network 100 further can include a plurality of fixed routers 107-1 through 107-n (referred to generally as nodes 107 or fixed routers 107 or fixed communication devices 107) for routing data packets between other nodes 102, 106 or 107. It is noted that for purposes of this discussion, the nodes discussed above can be collectively referred to as “nodes 102, 106 and 107”, or simply “nodes” or alternatively as “communication devices.”

As can be appreciated by one skilled in the art, the nodes 102, 106 and 107 are capable of communicating with each other directly, or via one or more other nodes 102, 106 or 107 operating as a router or routers for packets being sent between nodes. As illustrated in FIG. 1, each node communicates with other neighboring nodes using a transmitting link and a receiving link associated with the node and each of the neighboring nodes. For example, node 102-N, as illustrated, communicates with node 107-N using a transmitting link 110-A and a receiving link 120-A, communicates with node 106-N using a transmitting link 110-B and a receiving link 120-B, and communicates with node 102-7 using a transmitting link 110-C and a receiving link 120-C. Associated with each communication link (i.e. each transmitting link 110 and each receiving link 120) are one or more transaction feedback of one or more packetized communications. The transaction feedback can include, for example, one or more success ratios, packet size information, data rate information, signal-to-noise ratio, signal quality, noise, bit-error rate, frequency channel, time-slot, antenna information and signal strength estimation information. The success ratios, for example, can include one or more data packet success ratios and one or more control packet success ratios. The packet success ratio is the fraction of packets that are correctly delivered prior to expiration of their deadlines. For MAC methods that use control packets to perform a handshake protocol to coordinate the transmission of the actual data, the overall packet success ratio depends on the control packet success ratio and the data packet success ratio.

As will be appreciated by those of ordinary skill in the art, the communication network 100 has one or more system parameters associated therewith. The system parameters, for example, can include system overhead information. The overhead information, for example, can include information pertaining to at least one of signaling time, acknowledgement (ACK) processing time, ACK time, ACK time-out, back-off time, fairness time and congestion time relating to the communications between the nodes. The one or more system parameters can further include packet size information, data rate information, signal-to-noise ratio, signal quality, noise, bit-error rate, frequency channel, time-slot, antenna information and signal strength estimation information. a data rate, a data size, a header, a request to send, a clear to send, a frame size, a channel access, a back-off timer, a duration of a successful message transmission, a duration of a successful data packet transmission, a duration of a successful control packet transmission, a time period required if a data packet transmission fails, and a time period required if a control packet transmission fails. When the communication network 100 is an 802.11 network, the one or more system parameters can include a slot time, a Short InterFrame Space (SIFS) time, a Distributed Interframe Space (DIFS) time, a minimum contention window, a maximum contention window, a Physical Layer Convergence Protocol (PLCP) preamble duration, and a PLCP header duration. When the communication network 100 is a MEA network, the system parameters can include a request to send transmission time, a clear to send processing sign, a clear to send transmission time, a data processing time, a data retune time, a data transmission time, an acknowledgement processing time, and an acknowledgement transmission time.

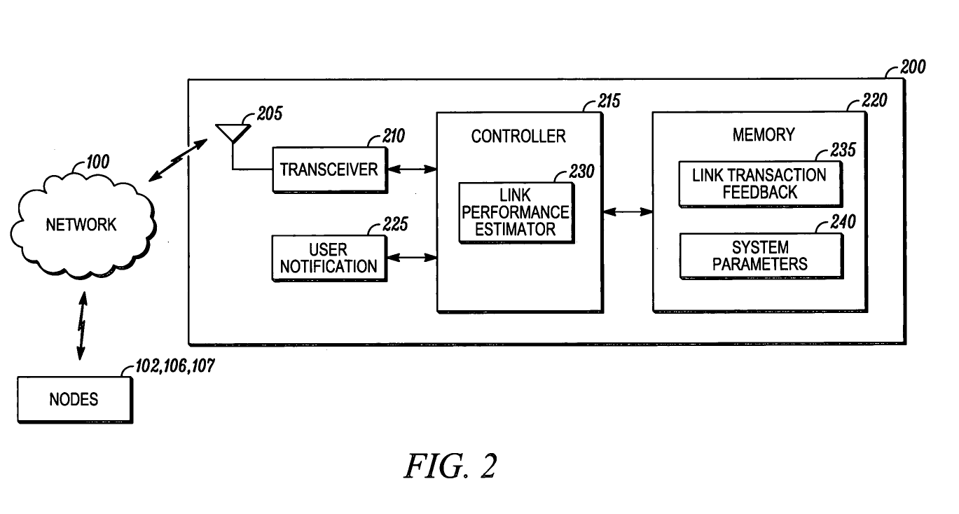

FIG. 2 is an electronic block diagram of one embodiment of a communication device 200 in accordance with the present invention. The communication device 200, for example, can exemplify one or more of the nodes 102, 106, and 107 of FIG. 1. As illustrated, the communication device 200 includes an antenna 205, a transceiver (or modem) 210, a controller 215, a user notification means 225, and a memory 220.

The antenna 205 intercepts transmitted signals from one or more nodes 102, 106, 107 within the communication network 100 and transmits signals to the one or more nodes 102, 106, 107 within the communication network 100. The antenna 205 is coupled to the transceiver 210, which employs conventional demodulation techniques for receiving and transmitting communication signals, such as packetized signals, to and from the communication device 200 under the control of the controller 215. The packetized data signals can include, for example, voice, data or multimedia information, and packetized control signals, including node update information. When the transceiver 210 receives a command from the controller 215, the transceiver 210 sends a signal via the antenna 205 to one or more devices within the communication network 100. In an alternative embodiment (not shown), the communication device 200 includes a receive antenna and a receiver for receiving signals from the communication network 100 and a transmit antenna and a transmitter for transmitting signals to the communication network 100. It will be appreciated by one of ordinary skill in the art that other similar electronic block diagrams of the same or alternate type can be utilized for the communication device 200.

Coupled to the transceiver 210, is the controller 215 utilizing conventional signal-processing techniques for processing received messages. It will be appreciated by one of ordinary skill in the art that additional processors can be utilized as required to handle the processing requirements of the controller 215.

In accordance with the present invention, the controller 215 includes a link performance estimator 230 for estimating the performance of the various links in which the communication device 200 is connected within the communication network 100. It will be appreciated by those of ordinary skill in the art that the link performance estimator 230 can be hard coded or programmed into the communication device 200 during manufacturing, can be programmed over-the-air upon customer subscription, or can be a downloadable application. It will be appreciated that other programming methods can be utilized for programming the link performance estimator 230 into the communication device 200. It will be further appreciated by one of ordinary skill in the art that the link performance estimator 230 can be hardware circuitry within the communication device 200. In accordance with the present invention, the link performance estimator 230 can be contained within the controller 215 as illustrated, or alternatively can be an individual block operatively coupled to the controller 215 (not shown).

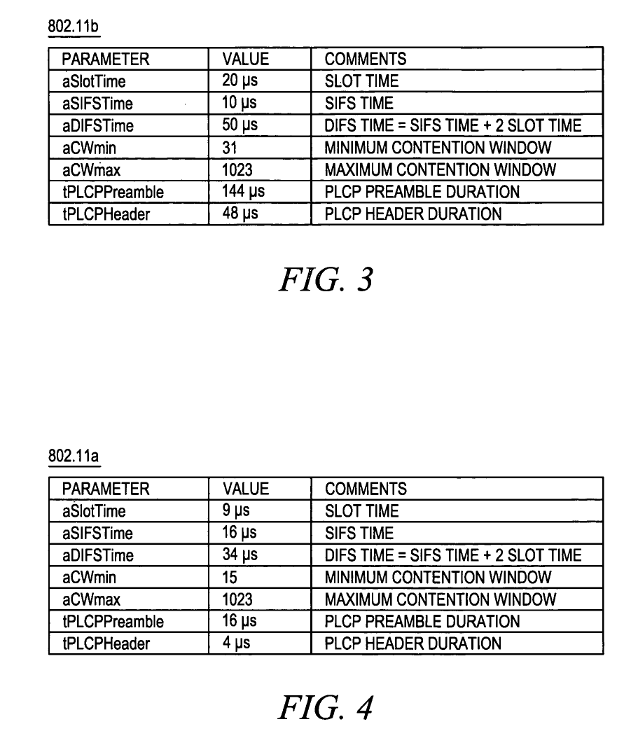

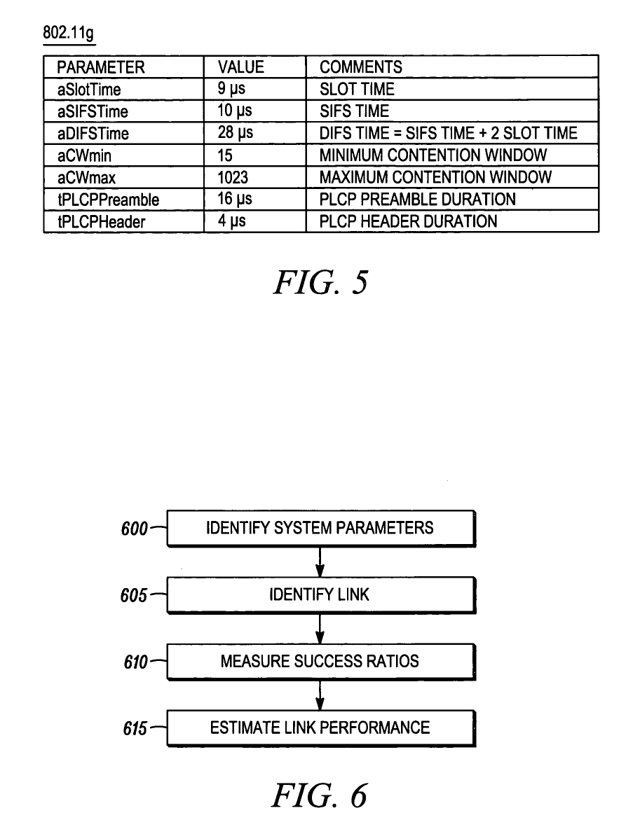

To perform the necessary functions of the communication device 200, the controller 215 is coupled to the memory 220, which preferably includes a random access memory (RAM), a read-only memory (ROM), an electrically erasable programmable read-only memory (EEPROM), and flash memory. The memory 220, in accordance with the present invention, includes storage locations for the storage of one or more link transaction feedback 235, one or more system parameters, 240, and the like. FIGS. 3 through 5 illustrate exemplary system parameters 240 that may be stored in the memory 220 for an 802.11b network, an 802.11a network, and am 802.11g network respectively.

It will be appreciated by those of ordinary skill in the art that the memory 220 can be integrated within the communication device 200, or alternatively, can be at least partially contained within an external memory such as a memory storage device. The memory storage device, for example, can be a subscriber identification module (SIM) card. A SIM card is an electronic device typically including a microprocessor unit and a memory suitable for encapsulating within a small flexible plastic card. The SIM card additionally includes some form of interface for communicating with the communication device 200.

Preferably, the user notification means 225 is coupled to the controller 215. The user notification means 225, for example, can be a visual notification on a display. The display can be, for example, a liquid crystal display utilized to display text and graphics. It will be appreciated by one of ordinary skill in the art that other similar displays such as cathode ray tube displays, organic light emitting diodes, LEDs, or plasma displays can be utilized for the display. Alternatively, the user notification means 225 can be an alert using, for example, a speaker with associated speaker drive circuitry capable of playing melodies and other audible alerts, a vibrator with associated vibrator drive circuitry capable of producing a physical vibration, or one or more LEDs (not shown) with associated LED drive circuitry capable of producing a visual alert. It will be appreciated by one of ordinary skill in the art that other similar notification means as well as any combination of the audible, vibratory, and visual alert outputs described can be used for the user notification means 225.

FIG. 6 is a flowchart illustrating one embodiment of the operation of the link performance estimator 230 in accordance with the present invention. Specifically, FIG. 6 illustrates an operation of estimating link performance in a packetized communication network. As illustrated, the process begins with Step 600 in which the link performance estimator 230 identifies one or more system parameters of the packetized communication network in which the communication device 200 is operating. The system parameters, for example, can be retrieved from the memory 220 as described previously herein. Next, in Step 605, the link performance estimator 230 identifies a link in which performance information is required/desired. The link, for example, can be a communication link within the packetized communication network in which the communication device is receiving or transmitting messages.

Next, in Step 610, the link performance estimator 230 obtains one or more transaction feedback 235 of one or more packetized communications within the identified communication link of the packetized communication network. In one embodiment, the transaction feedback 235 can be stored in the memory 220 of the communication device 200. For example, when the transaction feedback 235 includes one or more transmit success counts, the success ratios can be calculated using, for example, using the methods described in U.S. patent application No. 20040260808 entitled “Method to provide a measure of link reliability to a routing protocol in an ad hoc wireless network”, filed on Jun. 7, 2004, and assigned to the assignee of the present invention, the entire content of which being incorporated herein by reference.

Next, in Step 615, the link performance estimator 230 estimates performance of the communication link using the identified system parameters and the obtained transaction feedback. Step 615, for example can include calculating the link performance at a particular hop using the following equation:

$$G = \frac{L}{{T}_{d} + {T}_{q} + {T}_{w 0}}$$

$${T}_{d} = \frac{{t}_{sd}}{{pcr}_{d}} + \frac{{t}_{sc}}{{pcr}_{d} {pcr}_{c}} + \frac{{t}_{e} ( 1 - {pcr}_{d} {pcr}_{c} )}{{pcr}_{d} {pcr}_{c}}$$

where:

G is the effective throughput (goodput)

T_{d} is the average message transmission delay

T_{q} is the average queuing delay

T_{W0} is the average initial channel contention delay

L is the average packet size

pcr_{d}(h) is the data packet success ratio

pcr_{c}(h) is the control packet success ratio

t_{sc}(h) is the duration of successful control packet transmissions

t_{sd}(h) is the duration of successful data packet transmissions

tₑ(h) is the extra time required if the packet transmission fails

The benefits of selecting a route using a link performance estimation that takes into account system parameters as well as feedback from a lower layer component (such as the Physical Layer or the Medium Access Controller) are threefold. Firstly, the link performance estimation is directly related to the maximum performance that is possible to attain using a communication link. In a communication network, it is preferable to estimate the performance of the link before new traffic is being sent over it, because localized failures may lead to generalized network instability. Secondly, the link performance estimation described in the current invention only requires a minimum amount of feedback to operate: namely the count of successful and failed transmission. Thirdly, the operations described can be implemented using a comparatively small amount of memory in a microprocessor, making an embedded implementation especially attractive if the number of neighbors one node must keep track of is comparatively large.

For an implementation in a multihopping wireless network, the metric M is defined by considering the link performance metric G(h) which is based on the effective throughput (goodput) at each hop h:

$$\{ M = α \cdot {\sum }_{h = 1}^{H} G ( h )$$

where a is an arbitrary scaling factor. The usefulness of the link performance indicator will be illustrated by assuming that G=L/T_{d} (and therefore, that T_{q} and T_{w0} are comparatively small). The metric can therefore be written as

$$M = \frac{α}{L} \cdot {\sum }_{h = 1}^{H} ( \frac{\begin{matrix}{t}_{sc} ( h ) + {t}_{sd} ( h ) \cdot {pcr}_{c} ( h ) + \\ {t}_{e} ( 1 - {pcr}_{d} ( h ) \cdot {pcr}_{c} ( h ) )\end{matrix}}{{pcr}_{d} ( h ) \cdot {pcr}_{c} ( h )} ) = \frac{α}{L} \cdot {\sum }_{h = 1}^{H} \frac{{t}_{s} ( h )}{LQ ( h )}$$

$$where$$

$$LQ ( h ) = \frac{{t}_{s} ( h ) \cdot {pcr}_{d} ( h ) \cdot {pcr}_{c} ( h )}{{t}_{sc} ( h ) + {t}_{sd} ( h ) \cdot {pcr}_{c} ( h ) + {t}_{e} ( 1 - {pcr}_{d} ( h ) \cdot {pcr}_{c} ( h ) )}$$

Since tₛ(h) is the transmission time in the event that there is no error, LQ(h) is a true measure of the link's performance, irrespective of the traffic load. LQ(h) of 1 indicates a flawless link, while LQ(h) of 0.5 indicates that the link can only achieve 50% (fifty percent) of its nominal capacity. Such an indicator can be efficiently used in a wireless network because it can compare routes with one another and detect link failures.

To exemplify the present invention, an example wherein the communications network 100 is an 802.11 network is described below.

802.11 Networks: 802.11b, 802.11g and 802.11a use the same MAC protocol. The following section describes the MAC overhead for 802.11 networks.

Assumptions:

1) The message transmission consists of two parts: control packets transmission (RTS/CTS) and data packets transmission (DATA/ACK). pcr_{c} corresponds to the successful transmissions of RTS and CTS while pcr_{d} corresponds to the successful transmissions of DATA (only data failure is considered, ACK failure is ignored).

2) A packet is subject to three delays: a) queueing delay; b) initial channel contention delay; c) packet transmission delay including retries.

3) The final computation is done by assuming an infinite retry limit.

4) The same transmission parameters are used for the retries of the same packet. The aim is to find total time required for successful transmission of a packet with a selected rate.

5) The threshold below which there is no RTS/CTS exchange is set to an arbitrarily low value (i.e. below the minimum packet size). The overhead computation can be extended to accomodate two sets of overhead, one for packets smaller than the RTS/CTS threshold, another for packets larger than the RTS/CTS threshold. If no RTS/CTS exchange occurs, the corresponding times should be subtracted from the overall delay computation. Similarly, if a group acknowledgment is used, the fragmentation computation should be modified accordingly. The formulations presented in this document can be easily changed for this purpose.

6) Propagation delays in the wireless medium are ignored.

The table below describes each of the symbols to be used in the equations herein.

| Symbol | Description |
|---|---|
| T_{failure} | Transmission time in the event of a failure |
| tₛ | Transmission time in the event of a success |
| T_{success} | Transmission time in the event of a success |
| t_{sd} | Transmission time of data part in the event of a |
| | success |
| t_{sc} | Transmission time of control part in the event of |
| | a success |
| CWmin | Minimum contention window |
| CWmax | Maximum contention window |
| L | Packet length in bytes |
| R | Data rate |
| R_{b} | Control packet rate (RTS and CTS) |
| R′_{b} | Control packet rate (ACK) |
| aSlotTime | Slot duration |
| T_{bckoff} | Average backoff time |
| I | Number of consecutive transmission failures |
| tᵣₜₛ | RTS duration |
| t_{cts} | CTS duration |
| t_{data} | Data packet duration |
| aDIFSTime | DIFS duration |
| aSIFSTime | SIFS duration |
| T_{failure}_{_{—}}data | Transmission time in the event of a data failure |
| t_{ack} | Transmission time of an acknowledgment |
| t_{csma} | Waiting time due to the contention in the shared |
| | medium |
| t_{ed} | Extra time required for transmission when data |
| | packet's transmission fails |
| T_{failure}_{_{—}}control | Transmission time in the event of a control failure |
| t_{ack}_{_{—}}tout | Acknowledgment timeout duration |
| R_{Sb} | OFDM bits per symbol for control packet |
| Rₛ | OFDM bits per symbol for data packet |
| tPLCPPreamble | PLCP Preamble duration |
| tPLCPHeader | PLCP header duration |
| t_{ec} | Extra time required for transmission when control |
| | packet's transmission fails |
| tₑ | Extra time required for transmission whem |
| | message transmission fails |
| L | Packet size |
| T_{d} | Average packet delay |
| T_{q} | Average queuing delay |
| T_{w0} | Initial waiting delay before first transmission |
| | attempt |
| pcr_{c} | Control packet completion rate |
| pcr_{d} | Data packet completion rate |
| G | Goodput (Effective throughput) |
| T_{success}_{_{—}}control | Transmission time of control part in the event of |
| | a success |
| t_{fragment} | Fragment packet duration |
| L_{f} | Fragment packet size |
| t_{fr} | Average time to transmit a fragment and |
| | associated ACK |
| T_{success}_{_{—}}data | Transmission time of data part in the event of a |
| | success |
| t_{cts}_{_{—}}tout | CTS timeout duration |
| T_{d} | Average time to transmit a packet |
| pcr_{df} | Fragment packet completion rate |

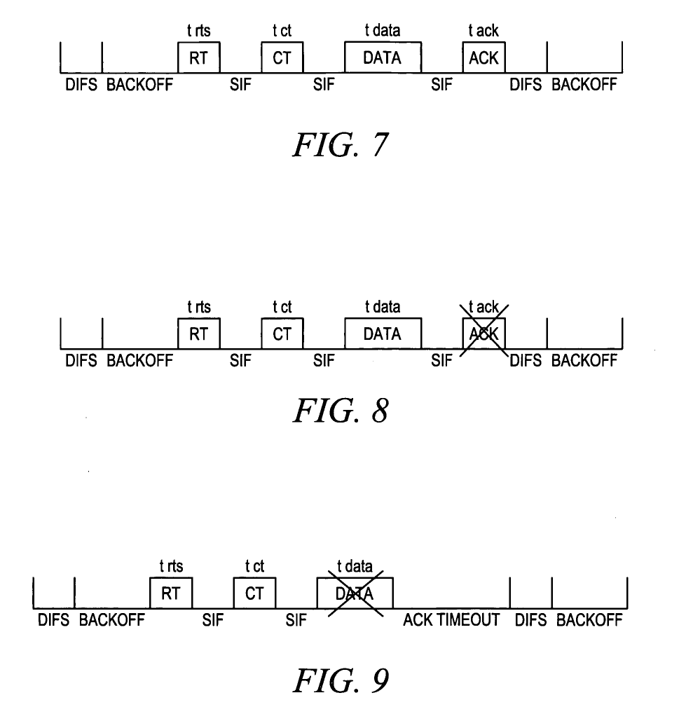

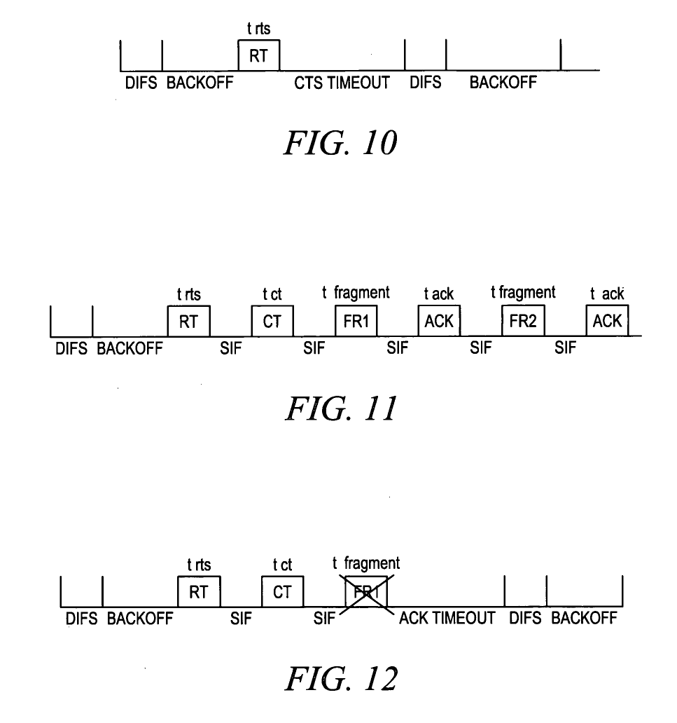

FIG. 7 illustrates an exemplary successful transmission in an 802.11 network. FIG. 8 illustrates a transmission failure due to a reception in error at the receiver. FIG. 9 illustrates a transmission failure due to a data failure. FIG. 10 illustrates a transmission failure due to a CTS Timeout. Note that the backoff durations after failures are incremented as described below. T_{failure} depends on the number of retries. The average backoff time after i consecutive unsuccessful transmission attempts is:

$${T}_{bkoff} ( i ) = \{ \begin{matrix}\frac{{2}^{i} ( CW min + 1 ) - 1}{2} aSlotTime & 0 \leq i < 6 \\ \frac{CW max}{2} aSlotTime & i \geq 6\end{matrix}$$

T_{success}(L,R,R_{b},R′_{b})=tᵣₜₛ(R_{b})+aSIFSTime+t_{cts}(R_{b})+aSIFSTime+t_{data}(L,R)+aSIFSTime+t_{ack}(R′_{b})+aD
tₛ(L,R,R_{b},R′_{b})=T_{success}(L,R,R_{b},R′_{b})=t_{sd}(L,R,R′_{b})+t_{sc}(R_{b})
where
t_{sd}(L,R,R′_{b})=t_{data}(L,R)+aSIFSTime+t_{ack}(R′_{b})+aDIFSTime+T_{bkoff}(0)
and
t_{sc}(R_{b})=tᵣₜₛ(R_{b})+aSIFSTime+t_{cts}(R_{b})+aSIFSTime
T_{failure}_{_{—}}_{data}(L,R,R_{b},j)=tᵣₜₛ(R_{b})+aSIFSTime+t_{cts}(R_{b})+aSIFSTime+t_{data}(L,R)+t_{ack}_{_{—}}ₜₒᵤₜ+aDIFSTime+T_{bkoff}(j)+t_{csma}
T_{failure}_{_{—}}_{control}(R_{b},j)=tᵣₜₛ(R_{b})+t_{cts}_{_{—}}ₜₒᵤₜ+aDIFSTime+T_{bkoff}(j)+t_{csma}
T_{failure} can be written in terms of T_{success} as:
T_{faiiure}_{_{—}}_{data}(L,R,R_{b},j)=T_{success}(L,R,R_{b},R′_{b})+t_{ed}=tₛ_{_{—}}_{d}(L,R,R′_{b})+tₛ_{_{—}}_{c}(R_{b})+t_{ed}+t_{csma}
where
t_{ed}=t_{ack}_{₁₃} ₜₒᵤₜ(R_{b})−aSIFSTime−t_{ack}(R′_{b})+T_{bkoff}(j)−T_{bkoff}(0)+t_{csma}
Similarly for the control channel:
T_{failure}_{_{—}}_{control}(R_{b},j)=T_{success}_{_{—}}_{control}(R_{b})+t_{ec}=t_{sc}(R_{b})+t_{ec}+t_{csma}
where
t_{ec}=t_{cts}_{_{—}}ₜₒᵤₜ+aDIFSTime+T_{bkoff}(j)−aSIFSTime−t_{cts}(R_{b})−aSIFSTime+t_{csma}=t_{cts}_{_{—}}ₜₒᵤₜ−t_{cts}(R_{b})−aSIFSTime+2SlotTime+T_{bkoff}(j)+t_{csma}
and
t_{csma}=waiting time due to the contention in the shared medium

The parameters used in the computation of transmission time are described for 802.11b, g and a in the following sections.

For 802.11b:
t_{data}=tPLCPPreamble+tPLCPHeader+(L)*8/R¹

¹ 28 bytes of MAC header are included in L.

t_{ack}=tPLCPPreamble+tPLCPHeader+(14)*8/R_{b}

For 802.11a and 802.11g:
t_{data}=tPLCPPreamble+tPLCPHeader+┌(L+22/8)*8/R_{S}┐tₛ
t_{ack}=tPLCPPreamble+tPLCPHeader+┌(14+22/8)*8/R_{Sb}┐tₛ
Rₛ and R_{Sb} are the bits per symbol for data bits and acknowledgement packets respectively, while tₛ is the symbol duration. The RTS is 20 bytes long while CTS is 14 bytes long. They are both transmitted at the base rates.

For 802.11b:
tᵣₜₛ=tPLCPPreamble+tPLCPHeader+20*8/R_{b}
t_{cts}=tPLCPPreamble+tPLCPHeader+14*8/R_{b}

For 802.11a and 802.11g:
tᵣₜₛ=tPLCPPreamble+tPLCPHeader+┌(20+22/8)*8/R_{Sb}┐tₛ
t_{cts}=tPLCPPreamble+tPLCPHeader+┌(14+22/8)*8/R_{Sb}┐tₛ
R_{Sb} is the bits per symbol while tₛ is the symbol duration.
When the limit of the number of transmissions per packet approaches infinity and averaging T_bkoff(j) to (CWmin+Cwmax)/2, T_{d} can be approximated as²:
² For simplicity, arguments of the functions are omitted (e.g. pcr_{c}(R_{b})=pcr_{c}).

$${T}_{d} = {\sum }_{n = 1}^{∞} {\sum }_{m = 1}^{∞} \frac{( m + n - 2 ) !}{( m - 1 ) ! ( n - 1 ) !} {pcr}_{c}^{m} {{pcr}_{d} ( 1 - {pcr}_{c} )}^{n - 1} {( 1 - {pcr}_{d} )}^{m - 1} ( m {t}_{ sd} + ( n + m - 1 ) {t}_{ sc} + ( m - 1 ) {t}_{ ed}$$

By using series approximations, the following equation is derived:

$${T}_{d} = \frac{{t}_{sd}}{{pcr}_{d}} + \frac{{t}_{sc}}{{pcr}_{d} {pcr}_{c}} + \frac{{t}_{ed} ( 1 - {pcr}_{d} )}{{pcr}_{d}} + \frac{{t}_{ec} ( 1 - {pcr}_{c} )}{{pcr}_{d} {pcr}_{c}}$$

$$If {t}_{ed} \approx {t}_{ec} ≡ {t}_{e}$$

$${T}_{d} = \frac{{t}_{sd}}{{pcr}_{d}} + \frac{{t}_{sc}}{{pcr}_{d} {pcr}_{c}} + \frac{{t}_{e} ( 1 - {pcr}_{d} {pcr}_{c} )}{{pcr}_{d} {pcr}_{c}}$$

For a given signal strength, the effective throughput can be computed as:

$$G = \frac{L}{{T}_{d} + {T}_{q} + {T}_{w 0}}$$

A tagged packet that is successfully transmitted has three delay components: waiting delay (T_{q}) in the queue, initial channel access delay (T_{w0}) and transmission delay (T_{d}) including the retransmission attempts. T_{d} can be computed by adding airtime and overhead using techniques known to one skilled the art. An example for the computation of T_{d} is presented herein. The average queuing delay T_{q} can be computed from the average queue size and packet delay T_{d}+T_{w0} since a new packet is enqueued, it has to wait for the packets that are already in the queue. There may be limitations in lifetime of packets, however dropping packets due to the lifetime or exceeding a certain number of retries should be infrequent and shouldn't change the average value. The initial channel access delay T_{w0} for the packet that becomes head of the queue can be approximated as t_{csma}·t_{csma} can be measured using channel monitoring times (e.g. CCA/NAV busyness).

Fragmentation

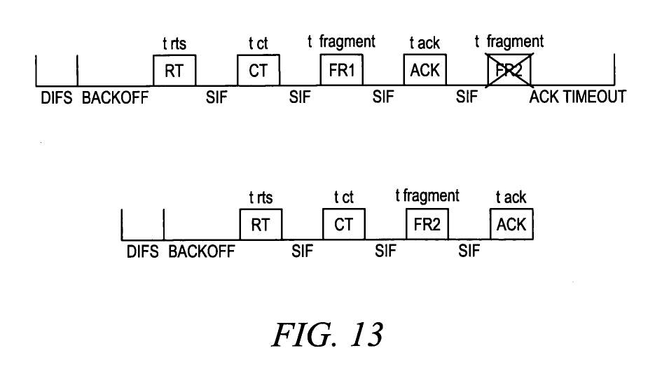

FIG. 11 illustrates a successful transmission of fragments in 802.11 networks (which use an immediate ACK policy). FIG. 12 illustrates a transmission failure due to the failure of the first fragment. FIG. 13 illustrates a transmission failure due to the failure of the second fragment which is retransmitted.

In addition to the assumptions described above, it is assumed that every fragment has the same packet completion rate and data length.

As described in the previous section, the total time as a function of successful and failure times can be written as
t_{sc}(R_{b})=tᵣₜₛ(R_{b})+aSIFSTime+t_{cts}(R_{b})+aSIFSTime+aDIFSTime+T_{bkoff}(0)
t_{fr}(L_{f},R, R′_{b})=t_{fragment}(L_{f},R)+2 aSIFSTime+t_{ack}(R′_{b})

For 802.11b:
t_{fragment}(L_{f},R)=tPLCPPreamble+tPLCPHeader+(L_{f})*8/R³
t_{ack}(R′_{b})=tPLCPPreamble+tPLCPHeader+(14)*8/R′_{b}

For 802.11a and 802.11g:
t_{fragment}(L_{f},R)=tPLCPPreamble+tPLCPHeader+┌(L_{f}+22/8)*8/R_{S}┐tₛ
t_{ack}(R′_{b})==tPLCPPreamble+tPLCPHeader+┌(14+22/8)*8/R_{Sb}┐tₛ
tᵣₜₛ, t_{cts} and mean_bkoff are computed as described in the previous section.
t_{fr}(L_{f},R,R′_{b})=t_{fragment}(L_{f},R)+2aSIFSTime+t_{ack}(R′_{b})
when n fragments are transmitted successfully:
T_{success}_{_{—}}_{data}(n,R,R_{b})=T_{sc}(R_{b})+n t_{fr}(L_{f},R, R′_{b})=t_{sc}(R_{b})+n t_{fr}(L_{f},R,R′_{b})
T_{failure} can be written in terms of T_{success} as the following when the n^{th} fragment fails:
T_{failure}_{_{—}}_{data}(n,R,j,R_{b})=T_{success}_{_{—}}_{data}(n,R,R_{b})+t_{ed}+t_{csma}=t_{sc}(R_{b})−T_{bkoff}(0)+T_{bkoff}(j)+t_{ack}_{_{—}}ₜₒᵤₜ−2aSIFSTime−t_{ack}(R′_{b})+n t_{fr}(L_{f},R,R′_{b})
where
t_{ed}=T_{bkoff}(j)−T_{bkoff}(0)+t_{ack}_{_{—}}ₜₒᵤₜ−2aSIFSTime−t_{ack}(R′_{b})+t_{csma}
where
t_{csma}=waiting time due to the contention in the shared medium
and
T_{failure}_{_{—}}_{control}(R_{b},j)=tᵣₜₛ(R_{b})+t_{cts}_{_{—}}ₜₒᵤₜ+aDIFSTime+T_{bkoff}(j)+t_{csma}
T_{failure}_{_{—}}_{control}(R_{b},j)=T_{sc}(R_{b})+t_{ec}=t_{sc}(R_{b})+t_{ec}=t_{sc}(R_{b})+t_{ec}
where
t_{ec}=t_{cts}_{_{—}}ₜₒᵤₜ−t_{cts}(R_{b})+T_{bkoff}(j)−T_{bkoff}(0)−2aSIFSTime+t_{csma}
where t_{csma}=waiting time due to the contention in the shared medium
The average time to transmit a fragmented packet can then be computed as:

$${T}_{d} = {\sum }_{n = 1}^{∞} {\sum }_{m = 1}^{∞} \frac{( m + n - 2 ) !}{( m - 1 ) ! ( n - 1 ) !} {\underbrace{( {\sum }_{k = 0}^{N} … {\sum }_{j = x}^{N} {\sum }_{i = j}^{N} ( N - i ) )}}_{( m - 1 ) times} {pcr}_{c}^{m} {{pcr}_{df}^{N} ( 1 - {pcr}_{c} )}^{n - 1} {( 1 - {pcr}_{df} )}^{m - 1} [ \begin{matrix}( N + m - 1 ) {t}_{sd} + ( n + m - 1 ) {t}_{sc} + \\ ( m - 1 ) {t}_{ ed} + {( n - 1 )}_{ {t}_{ ec}}\end{matrix} ]$$

$$where$$

$${\underbrace{{\sum }_{k = 0}^{N} … {\sum }_{j = x}^{N} {\sum }_{i = j}^{N} ( N - i )}}_{( m - 1 ) times} = \frac{Pochhammer [ N , m - 1 ]}{( m - 1 ) !} = \frac{1}{( m - 1 ) !} {\prod }_{i = 0}^{m - 2} ( N + i )$$

By using series approximations, the following equation is derived:

$${T}_{d} = \frac{N {t}_{sf}}{{pcr}_{df}} + \frac{{t}_{sc} ( {pcr}_{df} + N ( 1 - {pcr}_{df} ) )}{{pcr}_{df} {pcr}_{c}} + \frac{ {t}_{ ed} N ( 1 - {pcr}_{df} )}{ {pcr}_{ df}} + \frac{ {t}_{ ec} ( 1 - {pcr}_{c} ) ( {pcr}_{df} + N ( 1 - {pcr}_{df} ) )}{ {pcr}_{df} {pcr}_{c}}$$

If t_{ed}≈t_{ec}≡tₑ:

$${T}_{d} = \frac{N {t}_{sf}}{{pcr}_{df}} + \frac{{t}_{sc} ( {pcr}_{df} + N ( 1 - {pcr}_{df} ) )}{{pcr}_{df} {pcr}_{c}} + \frac{ {t}_{ e} ( {pcr}_{df} ( 1 - {prc}_{c} ) + N ( 1 - {pcr}_{df} ) )}{ {pcr}_{df} {pcr}_{c}}$$

It can be shown that for N=1 where t_{sf}=t_{sd} and pcr_{df}=pcr_{d}, T_{d} is the same as derived in previous section:

$${T}_{d} = \frac{{t}_{sd}}{{pcr}_{d}} + \frac{{t}_{sc}}{{pcr}_{d} {pcr}_{c}} + \frac{{t}_{e} ( 1 - {pcr}_{d} {pcr}_{c} )}{{pcr}_{d} {pcr}_{c}}$$

For a given signal strength, the effective throughput (goodput) can be computed as:

$$G = \frac{L}{{T}_{d} + {T}_{q} + {T}_{w 0}}$$

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method of estimating link performance in a packetized communication network comprising the steps of:
identifying one or more system parameters of the packetized communication network;
obtaining one or more transaction feedback of one or more packetized communications within a communication link of the packetized communication network; and
estimating performance of the communication link using the identified system parameters and the obtained transaction feedback.

2. A method of estimating link performance in a packetized communication network as claimed in claim 1, wherein the identifying one or more system parameters step comprises:
identifying one or more overhead information.

3. A method of estimating link performance in a packetized communication network as claimed in claim 2, wherein the overhead information comprises information pertaining to at least one of signaling time, acknowledgement (ACK) processing time, ACK time, ACK time-out, back-off time, fairness time and congestion time relating to the communications between the nodes.

4. A method of estimating link performance in a packetized communication network as claimed in claim 3, wherein the one or more system parameters are selected from a group of system parameters comprising a data rate, a data size, a header, a request to send, a clear to send, a frame size, a channel access, a back-off timer, a duration of a successful message transmission, a duration of a successful data packet transmission, a duration of a successful control packet transmission, a time period required if a data packet transmission fails, and a time period required if a control packet transmission fails.

5. A method of estimating link performance in a packetized communication network as claimed in claim 1, wherein the obtaining step comprises:
obtaining at least one transaction feedback selected from the group of transaction feedback comprising one or more success ratios, packet size information, data rate information, signal-to-noise ratio, signal quality, noise, bit-error rate, frequency channel, time-slot, antenna information and signal strength estimation information.

6. A method of estimating link performance in a packetized communication network as claimed in claim 1, wherein the packetized communication network comprises an 802.11 network, and further wherein the one or more system parameters are selected from a group of system parameters comprising a slot time, a Short InterFrame Space (SIFS) time, a Distributed Interframe Space (DIFS) time, a minimum contention window, a maximum contention window, a PLCP preamble duration, and a Physical Layer Convergence Protocol (PLCP) header duration.

7. A method of estimating link performance in a packetized communication network as claimed in claim 1, wherein the packetized communication network comprises a mesh enabled (MEA) network, and further wherein the one or more system parameters are selected from a group of system parameters comprising a request to send transmission time, a clear to send processing sign, a clear to send transmission time, a data processing time, a data retune time, a data transmission time, an acknowledgement processing time, and an acknowledgement transmission time.

8. A method of estimating link performance in a packetized communication network as claimed in claim 5, wherein the one or more success ratios comprises a data packet success ratio.

9. A method of estimating link performance in a packetized communication network as claimed in claim 5, wherein the one or more success ratios comprises a control packet success ratio.

10. A method of estimating link performance in a packetized communication network as claimed in claim 1, wherein the estimating step comprises:
calculating the link performance using the following equation:
$$G = \frac{L}{{T}_{d} + {T}_{q} + {T}_{w 0}}$$
$${T}_{d} = \frac{{t}_{sd}}{{pcr}_{d}} + \frac{{t}_{sc}}{{pcr}_{d} {pcr}_{c}} + \frac{{t}_{e} ( 1 - {pcr}_{d} {pcr}_{c} )}{{pcr}_{d} {pcr}_{c}}$$
where:
G is the effective throughput (goodput)
T_{d} is the average message transmission delay
T_{q} is the average queuing delay
T_{w0} is the average initial channel contention delay
L is the average packet size
pcr_{d}(h) is the data packet success ratio
pcr_{c}(h) is the control packet success ratio
t_{sc}(h) is the duration of successful control packet transmissions
t_{sd}(h) is the duration of successful data packet transmissions
tₑ(h) is the extra time required if the packet transmission fails

11. A communication device operating within a packetized communication network, the communication device comprising:
a link performance estimator adapted to:
identify one or more system parameters of the packetized communication network;
obtain one or more transaction feedback of one or more packetized communications within a communication link of the packetized communication network; and
estimate performance of the communication link using the identified system parameters and the obtained transaction feedback.

12. A communication device as claimed in claim 11 further comprising:
a memory coupled to the link performance estimator for storing the one or more system parameters,
wherein the link performance estimator estimates performance of the communication link using the stored one or more system parameters.

13. A communication device as claimed in claim 11 further comprising:
a transceiver coupled to the link performance estimator for receiving the one or more packetized communications including associated transaction feedback,
wherein the link performance estimator measures one or more success ratios of the transaction feedback in response to the transceiver receiving the one or more packetized communications from the transceiver.

14. A communication device as claimed in claim 11 further comprising:
a user notification means for notifying a user of the communication device of the estimated link performance, wherein the user notification means is selected from a group of means comprising a visual display, an audible alert, a haptic alert, and an optical alert.

15. A communication device as claimed in claim 11, wherein the link performance estimator is programmed to estimate performance of the communication link using the following equation:
$$G = \frac{L}{{T}_{d} + {T}_{q} + {T}_{w 0}}$$
$${T}_{d} = \frac{{t}_{sd}}{{pcr}_{d}} + \frac{{t}_{sc}}{{pcr}_{d} {pcr}_{c}} + \frac{{t}_{e} ( 1 - {pcr}_{d} {pcr}_{c} )}{{pcr}_{d} {pcr}_{c}}$$
where:
G is the effective throughput (goodput)
T_{d} is the average message transmission delay
T_{q} is the average queuing delay
T_{w0} is the average initial channel contention delay
L is the average packet size
pcr_{d}(h) is the data packet success ratio
pcr_{c}(h) is the control packet success ratio
t_{sc}(h) is the duration of successful control packet transmissions
t_{sd}(h) is the duration of successful data packet transmissions
tₑ(h) is the extra time required if the packet transmission fails

16. A method of selecting a communication route within a packetized communication network comprising the steps of:
identifying one or more system parameters of the packetized communication network;
estimating performance of each of a plurality of communication links within the packetized communication network by:
obtaining one or more transaction feedback of one or more packetized communications within a communication link of the packetized communication network, and
estimating performance of the communication link using the identified system parameters and the obtained transaction feedback; and
selecting a communication route using each of the link performance estimations.
